(19) United States
(12) Patent Application Publication
(10) Pub. No.: US 2016/0278122 A1
(43) Pub. Date: Sep. 22, 2016

(54) HETEROGENEOUS NETWORK COMMUNICATION METHOD AND RELEVANT EQUIPMENT

(71) Applicant: China Mobile Communications Corporation, Beijing (CN)

(72) Inventors: Chengkang Pan, Beijing (CN); Zhengang Pan, Beijing (CN); Chihlin I, Beijing (CN)

(73) Assignee: China Mobile Communications Corporation, Beijing (CN)

(21) Appl. No.: 15/030,352

(22) PCT Filed: Oct. 17, 2014
(86) PCT No.: PCT/CN2014/088831

§ 371 Date: Apr. 18, 2016

(30) Foreign Application Priority Data
Oct. 18, 2013 (CN) 201310491795.6

(51) Int. Cl. H04W 74/02

(52) U.S. Cl. CPC H04W 74/02; H04W 84/045

(57) ABSTRACT

The present disclosure provides a heterogeneous network communication method and relevant equipment. The method includes steps of: enabling a mobile terminal to access a cellular communication system via a micro base station; when data signaling is to be transmitted between the mobile terminal and the micro base station, determining, by the mobile terminal, symbols to be occupied by the to-be-transmitted data signaling from symbols included in a microcell subframe; and transmitting the data signaling between the mobile terminal and the micro base station on the basis of the determined symbols. The technical solution of the present disclosure solves problems in the related art of low data transmission efficiency between the micro base station and the mobile terminal, low throughput of the micro base station, and long data transmission delay for the micro base station.

### CROSS-REFERENCE TO RELATED APPLICATION

The present application claims a priority of the Chinese patent application No. 201310491795.6 filed on Oct. 18, 2013, which is incorporated herein by reference in its entirety.

### TECHNICAL FIELD

The present disclosure relates to the field of communication technology, in particular to a heterogeneous network communication method and relevant equipment.

### BACKGROUND

In order to meet the increasing demand on service amount and service density, currently the international standardization organizations such as 3^{rd} Generation Partnership Project (3GPP) have proposed the introduction of new wireless nodes into a wireless network, i.e., microcell base stations (hereinafter referred to as micro base stations for short). The micro base station has a coverage range different from a macrocell base station (hereinafter referred to as macro base station for short), so the wireless network into which the micro base stations are introduced is usually called as a heterogeneous network.

In the heterogeneous network, the macro base station is operated at a low frequency band and covers a large region, so as to provide a mobile terminal with data transmission at medium and low speeds and enable the mobile terminal to access services with medium and high mobility. The micro base station is operated at a high frequency band (also at a low frequency band) and covers a small hotspot region indoor or outdoor, so as to provide the mobile terminal with data transmission at a high speed and enable the mobile terminal to access services with low mobility.

In the related art, an identical air-interface standard and an identical frame structure are adopted by both the macro base station and the micro base station, and frame synchronization is maintained therebetween. After the mobile terminal accesses a cellular communication system via the macro base station, information is transmitted between the mobile terminal and the macro base station on the basis of subframes. After the mobile terminal accesses the cellular communication system via the micro base station, information is also transmitted between the mobile terminal and the micro base station on the basis of subframes. In this way, it is able to simplify the design of the mobile terminal and facilitate the mobile terminal to switch between the macro base station and the micro base station.

However, depending on channel and service characteristics of microcells, usually burst data is transmitted between the micro base station and the mobile terminal, and each time merely a small volume of data is transmitted, so it is unnecessary to occupy a long timeslot. When the air-interface standard for the macro base station is directly applied to the micro base station, the efficiency of the data transmission between the micro base station and the mobile terminal as well as the throughput of the micro base station will be remarkably reduced, and thereby a relatively high data transmission delay will occur for the micro base station.

### SUMMARY

The present disclosure provides a heterogeneous network communication method and relevant equipment, which can solve problems in the related art of low data transmission efficiency between the micro base station and the mobile terminal, low throughput of the micro base station, and long data transmission delay for the micro base station.

The technical solutions of the present disclosure are as follows.

The present disclosure provides in some embodiments a heterogeneous network communication method, including steps of: enabling a mobile terminal to access a cellular communication system via a micro base station; when data signaling is to be transmitted between the mobile terminal and the micro base station, determining, by the mobile terminal, symbols to be occupied by the to-be-transmitted data signaling from symbols included in a microcell subframe; and transmitting the data signaling between the mobile terminal and the micro base station on the basis of the determined symbols.

According to the heterogeneous network communication method in the embodiments of the present disclosure, with respect to the burst data transmitted between the micro base station and the mobile terminal and at a small data volume each time, after the mobile terminal in the embodiments of the present disclosure accesses the cellular communication system via the micro base station, the data signaling is transmitted between the mobile terminal and the micro base station on the basis of the symbols rather than the subframes. The mobile terminal determines the symbols to be occupied by the data signaling from the symbols included in the microcell subframe, and then the data signaling is transmitted between the mobile terminal and the micro base station on the basis of the determined symbols. As a result, it is able to effectively improve the efficiency of the data transmission between the micro base station and the mobile terminal as well as the throughput of the micro base station, thereby to reduce the data transmission delay for the micro base station.

Optionally, the number of the symbols included in the microcell subframe is greater than the number of the symbols included in a macrocell subframe, so as to further improve the efficiency of the data transmission between the micro base station and the mobile terminal as well as the throughput of the micro base station.

Optionally, the macrocell subframe includes M symbols, a macrocell frame includes N macrocell subframes, a macrocell superframe includes L macrocell frames. The microcell subframe includes K symbols, a microcell frame includes N microcell subframes, a microcell superframe includes L microcell frames, and K is greater than M.

Optionally, frame synchronization is maintained between the microcell subframe and the macrocell subframe, so as to switch the data transmission between a macrocell and a microcell rapidly and smoothly.

Optionally, the step of determining, by the mobile terminal, the symbols to be occupied by the to-be-transmitted data signaling from the symbols included in the microcell subframe includes: when the mobile terminal is currently in a preconfigured contention access period, determining, by the mobile terminal, the symbols to be occupied by the to-be-transmitted data signaling from the symbols included in the microcell subframe in a contention access mode; and when the mobile terminal is currently in a preconfigured contention-free access period, determining, by the mobile terminal, the symbols to be occupied by the to-be-transmitted data signaling from the symbols included in the microcell subframe in a contention-free access mode. The data signaling is transmitted in the contention access period between the micro base station and the mobile terminal in the contention access mode and transmitted in the contention-free access period between the micro base station and the mobile terminal in the contention-free access mode, and as a result, it is able to transmit the data signaling in a flexible manner.

Optionally, several subframes of the microcell frame or several symbols of the microcell subframe are occupied by each contention access period.

Optionally, the heterogeneous network communication method further includes receiving high-layer signaling for the micro base station from a macro base station to which the micro base station belongs. In this way, a data plane and a control plane of the mobile terminal are separated from each other. The control plane is mainly controlled by the macro cell and includes access management and mobility management, and the microcell mainly takes charge of the data communication at the data plane. As a result, it is able to reduce a large number of processing resources for the micro base station, ensure the user experience, and facilitate the management and control of the mobile terminal.

The present disclosure provides in some embodiments a mobile terminal, including an access unit configured to access a cellular communication system via a micro base station, a symbol determination unit configured to, when data signaling is to be transmitted between the mobile terminal and the micro base station, determine symbols to be occupied by the to-be-transmitted data signaling from symbols included in a microcell subframe, and a data signaling transmission unit configured to transmit the data signaling between the mobile terminal and the micro base station on the basis of the determined symbols.

According to the mobile terminal in the embodiments of the present disclosure, with respect to the burst data transmitted between the micro base station and the mobile terminal and at a small data volume each time, after the mobile terminal in the embodiments of the present disclosure accesses the cellular communication system via the micro base station, the data signaling is transmitted between the mobile terminal and the micro base station on the basis of the symbols rather than the subframes. The mobile terminal determines the symbols to be occupied by the data signaling from the symbols included in the microcell subframe, and then the data signaling is transmitted between the mobile terminal and the micro base station on the basis of the determined symbols. As a result, it is able to effectively improve the efficiency of the data transmission between the micro base station and the mobile terminal as well as the throughput of the micro base station, thereby to reduce the data transmission delay for the micro base station.

Optionally, the symbol determination unit is configured to, when the mobile terminal is currently in a preconfigured contention access period, determine the symbols to be occupied by the to-be-transmitted data signaling from the symbols included in the microcell subframe in a contention access mode, and when the mobile terminal is currently in a preconfigured contention-free access period, determine the symbols to be occupied by the to-be-transmitted data signaling from the symbols included in the microcell subframe in a contention-free access mode. The data signaling is transmitted in the contention access period between the micro base station and the mobile terminal in the contention access mode and transmitted in the contention-free access period between the micro base station and the mobile terminal in the contention-free access mode, and as a result, it is able to transmit the data signaling in a flexible manner.

Optionally, the mobile terminal further includes a high-layer signaling reception unit configured to high-layer signaling for the micro base station from a macro base station to which the micro base station belongs. In this way, a data plane and a control plane of the mobile terminal are separated from each other. The control plane is mainly controlled by the macro cell and includes access management and mobility management, and the microcell mainly takes charge of the data communication at the data plane. As a result, it is able to reduce a large number of processing resources for the micro base station, ensure the user experience, and facilitate the management and control of the mobile terminal.

The present disclosure provides in some embodiments a heterogeneous network communication method, including steps of: enabling, by a micro base station, a mobile terminal to access a cellular communication system; when data signaling is to be transmitted between the micro base station and the mobile terminal, determining, by the micro base station, symbols to be occupied by the to-be-transmitted data signaling from symbols included in a microcell subframe; and transmitting the data signaling between the micro base station and the mobile terminal on the basis of the determined symbols.

According to the heterogeneous network communication method in the embodiments of the present disclosure, with respect to the burst data transmitted between the micro base station and the mobile terminal and at a small data volume each time, after the mobile terminal in the embodiments of the present disclosure accesses the cellular communication system via the micro base station, the data signaling is transmitted between the mobile terminal and the micro base station on the basis of the symbols rather than the subframes. The micro base station determines the symbols to be occupied by the data signaling from the symbols included in the microcell subframe, and then the data signaling is transmitted between the mobile terminal and the micro base station on the basis of the determined symbols. As a result, it is able to effectively improve the efficiency of the data transmission between the micro base station and the mobile terminal as well as the throughput of the micro base station, thereby to reduce the data transmission delay for the micro base station.

Optionally, the number of the symbols included in the microcell subframe is greater than the number of the symbols included in a macrocell subframe, so as to further improve the efficiency of the data transmission between the micro base station and the mobile terminal as well as the throughput of the micro base station.

Optionally, the macrocell subframe includes M symbols, a macrocell frame includes N macrocell subframes, a macrocell superframe includes L macrocell frames, the microcell subframe includes K symbols, a microcell frame includes N microcell subframes, a microcell superframe includes L microcell frames, and K is greater than M.

Optionally, frame synchronization is maintained between the microcell subframe and the macrocell subframe, so as to switch the data transmission between a macrocell and a microcell rapidly and smoothly.

Optionally, the step of determining, by the micro base station, the symbols to be occupied by the to-be-transmitted data signaling from the symbols included in the microcell subframe includes: when the micro base station is currently in a preconfigured contention access period, determining, by the micro base station, the symbols to be occupied by the to-be-transmitted data signaling from the symbols included in the microcell subframe in a contention access mode: and when the micro base station is currently in a preconfigured contention-free access period, determining, by the micro base station, the symbols to be occupied by the to-be-transmitted data signaling from the symbols included in the microcell subframe in a contention-free access mode. The data signaling is transmitted in the contention access period between the micro base station and the mobile terminal in the contention access mode and transmitted in the contention-free access period between the micro base station and the mobile terminal in the contention-free access mode, and as a result, it is able to transmit the data signaling in a flexible manner.

Optionally, several subframes of the microcell frame or several symbols of the microcell subframe are occupied by each contention access period.

The present disclosure provides in some embodiments a micro base station, including an access unit configured to enable a mobile terminal to access a cellular communication system, a symbol determination unit configured to, when data signaling is to be transmitted between the micro base station and the mobile terminal, determine symbols to be occupied by the to-be-transmitted data signaling from symbols included in a microcell subframe, and a data signaling transmission unit configured to transmit the data signaling between the micro base station and the mobile terminal on the basis of the determined symbols.

According to the micro base station in the embodiments of the present disclosure, with respect to the burst data transmitted between the micro base station and the mobile terminal and at a small data volume each time, after the mobile terminal in the embodiments of the present disclosure accesses the cellular communication system via the micro base station, the data signaling is transmitted between the mobile terminal and the micro base station on the basis of the symbols rather than the subframes. The micro base station determines the symbols to be occupied by the data signaling from the symbols included in the microcell subframe, and then the data signaling is transmitted between the mobile terminal and the micro base station on the basis of the determined symbols. As a result, it is able to effectively improve the efficiency of the data transmission between the micro base station and the mobile terminal as well as the throughput of the micro base station, thereby to reduce the data transmission delay for the micro base station.

Optionally, the symbol determination unit is configured to, when the micro base station is currently in a preconfigured contention access period, determine the symbols to be occupied by the to-be-transmitted data signaling from the symbols included in the microcell subframe in a contention access mode; and when the micro base station is currently in a preconfigured contention-free access period, determine the symbols to be occupied by the to-be-transmitted data signaling from the symbols included in the microcell subframe in a contention-free access mode. The data signaling is transmitted in the contention access period between the micro base station and the mobile terminal in the contention access mode and transmitted in the contention-free access period between the micro base station and the mobile terminal in the contention-free access mode, and as a result, it is able to transmit the data signaling in a flexible manner.

### BRIEF DESCRIPTION OF THE DRAWINGS

FIG. 1 is a flow chart of a heterogeneous network communication method at a mobile terminal side according to a first embodiment of the present disclosure:

FIG. 2 is a schematic view showing a frame structure of a macrocell according to the first embodiment of the present disclosure;

FIG. 3 is a schematic view showing a frame structure of a microcell according to the first embodiment of the present disclosure:

FIG. 4 is a schematic view showing the configuration of a contention access period and a contention-free access period according to the first embodiment of the present disclosure;

FIG. 5 is another schematic view showing the configuration of the contention access period and the contention-free access period according to the first embodiment of the present disclosure;

FIG. 6 is a schematic view showing a mobile terminal according to a second embodiment of the present disclosure,

FIG. 7 is a flow chart of a heterogeneous network communication method at a micro base station side according to a third embodiment of the present disclosure; and

FIG. 8 is a schematic view showing a micro base station according to a fourth embodiment of the present disclosure.

### DETAILED DESCRIPTION OF THE EMBODIMENTS

Usually, burst data is transmitted between a micro base station and a mobile terminal, and each time merely a small volume of data is transmitted, so it is unnecessary to occupy a long timeslot. When an air-interface standard for a macro base station is directly applied to the micro base station, the efficiency of the data transmission between the micro base station and the mobile terminal as well as the throughput of the micro base station will be remarkably reduced, and thereby a relatively high data transmission delay will occur for the micro base station. In order to overcome these drawbacks, after a mobile terminal in the embodiments of the present disclosure accesses a cellular communication system via a micro base station, data signaling is transmitted between the mobile terminal and the micro base station on the basis of symbols rather than subframes. The mobile terminal determines the symbols to be occupied by the data signaling from symbols included in the subframe, and then the data signaling is transmitted between the mobile terminal and the micro base station on the basis of the determined symbols. As a result, it is able to effectively improve the efficiency of the data transmission between the micro base station and the mobile terminal as well as the throughput of the micro base station, thereby to reduce the data transmission delay for the micro base station.

The present disclosure will be described hereinafter in conjunction with the drawings and embodiments.

### First Embodiment

After a mobile terminal accesses a cellular communication system via a micro base station, information is transmitted between the mobile terminal and the micro base station in accordance with a frame structure of a microcell. To be specific, the mobile terminal may transmit data signaling to the micro base station in accordance with the frame structure of the microcell, and receive data signaling transmitted by the micro base station in accordance with the frame structure. A procedure of transmitting the data signaling from the mobile terminal to the micro base station and a procedure of receiving by the mobile terminal the data signaling from the micro base station will be described in this embodiment.

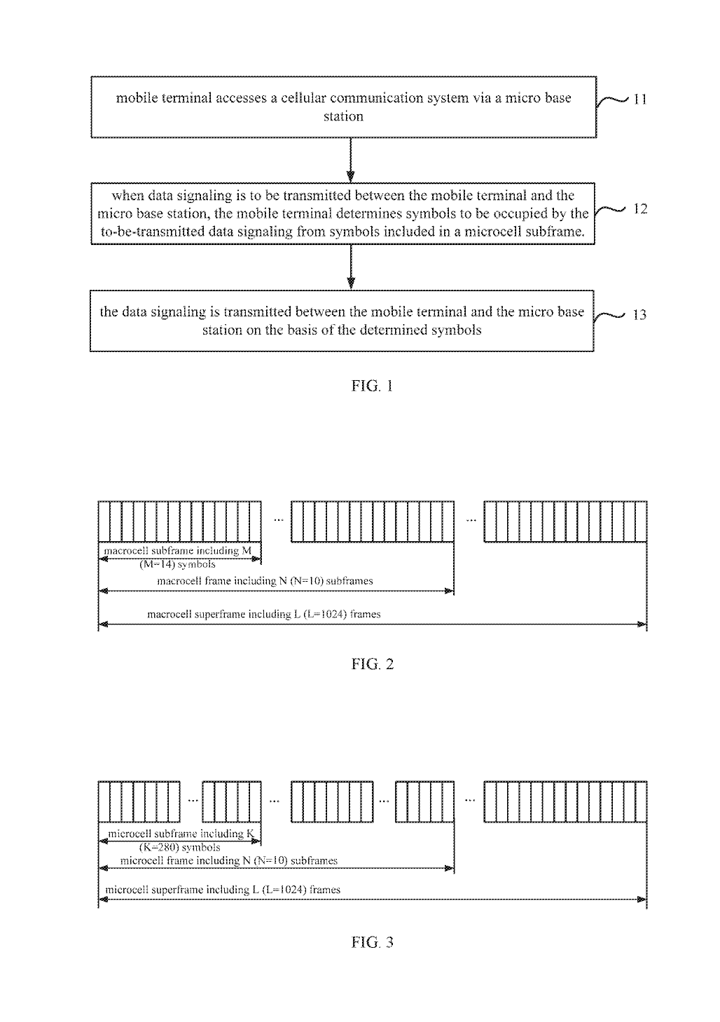

As shown in FIG. 1, the present disclosure provides in this embodiment a heterogeneous network communication method at a mobile terminal side, which includes the following steps.

At step 11, a mobile terminal accesses a cellular communication system via a micro base station.

To be specific, the mobile terminal may initially access the cellular communication system via a macro base station by default, and under some special conditions (e.g., when a fault or service saturation occurs for the macro base station), the mobile terminal may access the cellular communication system via the micro base station.

After the mobile terminal accesses the cellular communication system via the macro base station, information is transmitted between the mobile terminal and the macro base station in accordance with a frame structure of a macrocell. FIG. 2 shows the frame structure of the macrocell. A subframe of the macrocell (hereinafter referred to as macrocell subframe) includes M symbols, and each symbol represents a duration desired for transmitting an Orthogonal Frequency Division Multiplexing (OFDM) symbol. A frame of the macrocell (hereinafter referred to as macrocell frame) includes N macrocell subframes, and a superframe of the macrocell (hereinafter referred to as macrocell superframe) includes L macrocell frames. M may be 14, N may be 10, and L may be 1024. In other words, each macrocell subframe includes 14 symbols, each macrocell frame includes 10 macrocell subframes, and each macrocell superframe includes 1024 macrocell frames.

The information is transmitted between the mobile terminal and the macro base station on the basis of subframes. To be specific, when the information is to be transmitted from the mobile terminal to the macro base station, the mobile terminal may determine macrocell subframes to be occupied by the to-be-transmitted information, and then transmit the to-be-transmitted information to the macro base station on the basis of the determined macrocell subframes. The to-be-transmitted information may occupy all, or a part of, the symbols included in the macrocell subframe. When the information is to be received by the mobile terminal from the macro base station, the mobile terminal may determine macrocell subframes to be occupied by the information to be received, and then receive the information from the macro base station on the basis of the determined macrocell subframes. The received information may occupy all, or a part of, the symbols included in the macrocell subframe.

After the mobile terminal accesses the cellular communication system via the macro base station, a switch program may be enabled by the macro base station when the mobile terminal enters a coverage range of a certain micro base station, so as to switch the macro base station to the micro base station and enable the mobile terminal to access the cellular communication system via the micro base station. A procedure for switching the macro base station to the micro base station is known in the art, and thus will not be particularly defined herein.

At step 12, when data signaling is to be transmitted between the mobile terminal and the micro base station, the mobile terminal determines symbols to be occupied by the to-be-transmitted data signaling from symbols included in a microcell subframe.

In the related art, the macrocell and the microcell are independent of each other, and after the mobile terminal accesses the cellular communication system via the micro base station, both data-related signaling and data-independent signaling are transmitted by the micro base station to the mobile terminal. As a result, a large number of processing resources of the micro base station may be consumed, and it is difficult to ensure the user experience. For example, in order to achieve the switch control, each micro base station needs to periodically broadcast information about its own neighboring cells, and during the cell switch, the mobile terminal needs to receive the information broadcast by a plurality of micro base stations so as to determine a target cell. In this way, a normal service may be interrupted, a large number of processing resources of the micro base station may be consumed, and the management and control of the mobile terminal may be adversely affected.

In this embodiment of the present disclosure, after the mobile terminal accesses the cellular communication system via the micro base station, a data plane and a control plane of the mobile terminal may be separated from each other. The control plane is mainly controlled by the macro cell and includes access management and mobility management, and the microcell mainly takes charge of the data communication at the data plane. As a result, it is able to reduce a large number of processing resources for the micro base station, ensure the user experience, and facilitate the management and control of the mobile terminal.

The signaling transmitted between the mobile terminal and the micro base station may include data signaling and high-layer signaling. The data signaling refers to data-related signaling, and mainly includes data, information about a modulation mode of the data, information about a length of the data and transmission resource indication information. The high-layer signaling refers to data-independent signaling, and mainly includes system information and switching instruction. In the first embodiment of the present disclosure, merely the data signaling is to be transmitted between the mobile terminal and the micro base station, and the high-layer signaling for the micro base station is transmitted by a macro base station to which the micro base station belongs to the mobile terminal.

For example, when the cell switch procedure is to be performed by the mobile terminal, relevant switch parameters of a target cell (e.g., a signal-to-noise ratio, signal strength and a service saturation state of the target cell) may be transmitted by the macro base station to the mobile terminal. However, under some special conditions (e.g., when a fault or service saturation occurs for the macro base station), these parameters may also be transmitted by the micro base station to the mobile terminal.

At step 13, the data signaling is transmitted between the mobile terminal and the micro base station on the basis of the determined symbols.

In the related art, after the mobile terminal accesses the cellular communication system via the micro base station, the information is to be transmitted between the micro base station and the mobile terminal on the basis of subframes. Usually, the burst data is transmitted between the micro base station and the mobile terminal, and each time a small volume of data is transmitted, so it is unnecessary to occupy a long timeslot. When the information is transmitted on the basis of subframes, a few of the symbols included in the microcell subframe may be used to transmit the information each time. As a result, the efficiency of the data transmission between the micro base station and the mobile terminal as well as the throughput of the micro base station will be remarkably reduced, and thereby the high data transmission delay will occur for the micro base station. However, in the first embodiment of the present disclosure, the data signaling may be transmitted between the mobile terminal and the micro base station on the basis of symbols. In this way, it is able to prevent the occurrence of such a condition where merely a part of the symbols included in the microcell subframe are occupied by the to-be-transmitted data signaling, thereby to improve the efficiency of the data transmission between the micro base station and the mobile terminal as well as the throughput of the micro base station, and reduce the data transmission delay for the micro base station.

The transmission of the data signaling between the mobile terminal and the micro base station includes the transmission of the data signal from the mobile terminal to the micro base station and the transmission of the data signal from the micro base station to the mobile terminal. When the data signaling is transmitted from the mobile terminal to the micro base station, the mobile terminal may determine the symbols to be occupied by the to-be-transmitted data signaling from the symbols included in the microcell subframe, and then transmit the data signaling to the micro base station on the basis of the determined symbols. When the data signaling is transmitted from the micro base station to the mobile terminal, the mobile terminal may determine the symbols to be occupied by the to-be-transmitted data signaling from the symbols included in the microcell subframe, and then receive the data signaling from the micro base station on the basis of the determined symbols.

When the mobile terminal determines the symbols to be occupied by the to-be-transmitted data signaling, the number of the symbols to be occupied may be determined in accordance with a duration desired for transmitting the data signaling between the mobile terminal and the micro base station and a length of each symbol in the frame structure of the microcell. Then, the mobile terminal may determine the symbols desired for the transmission of the data signaling from the symbols included in the microcell subframe in accordance with the number of the symbols to be occupied.

A frame structure of the microcell may be identical to that of the macrocell. As shown in FIG. 2, a subframe of the microcell (hereinafter referred to as microcell subframe) includes M symbols, a frame of the microcell (hereinafter referred to microcell frame) includes N microcell subframes, and a superframe of the microcell (hereinafter referred to as microcell superframe) includes L microcell frames. M may be 14, N may be 10, and L may be 1024. In other words, each microcell subframe includes 14 symbols, each microcell frame includes 10 microcell subframes, and each microcell superframe includes 1024 microcell frames.

In addition, in order to further improve the efficiency of the data transmission between the micro base station and the mobile terminal as well as the throughput of the micro base station, the frame structure of the microcell may be reset in such a manner that the number of the symbols included in the microcell subframe is greater than the number of the symbols included in the macrocell subframe. At this point, a length of each symbol included in the microcell subframe is less than that of each symbol included in the macrocell subframe. FIG. 3 shows the frame structure of the microcell, where each microcell subframe includes K symbols, each microcell frame includes N microcell subframes, and each microcell superframe includes L microcell frames. K may be 280 (i.e., each microcell subframe includes 280 symbols), each microcell frame includes 10 microcell subframes, and each microcell superframe includes 1024 microcell frames.

In this embodiment of the present disclosure, frame synchronization may be maintained between the microcell subframe and the macrocell subframe, so as to switch the data transmission between the macrocell and the microcell rapidly and smoothly. In other words, a length of each microcell subframe (a product of the number of the symbols included in the microcell subframe and a length of each symbol) is equal to a length of each macrocell subframe (a product of the number of the symbols included in the macrocell subframe and a length of each symbol).

In the above-mentioned procedure, the mobile terminal may accesses the cellular communication system in a contention-free access mode, and may determine the symbols to be occupied by the to-be-transmitted data signaling from the symbols included in the microcell subframe, i.e., determine the symbols scheduled by the micro base station and desired for the transmission of the data signaling from the symbols included in the microcell subframe.

In addition, a contention access period and a contention-free access period may be configured for the micro base station by a resource management center at a network side, and then the contention access period, its corresponding contention access mode, the contention-free access period and its corresponding contention-free access mode may be notified by the macro base station to the mobile terminals. Of course, under some special conditions (e.g., when a fault or service saturation occurs for the macro base station), they may also be notified by the micro base station to the mobile terminals.

When the mobile terminal determines the symbols to be occupied by the to-be-transmitted data signaling, it may determine whether it is currently in the contention access period or the content-free access period. When the mobile terminal is currently in the contention access period, the mobile terminal may determine the symbols to be occupied by the to-be-transmitted data signaling from the symbols included in the microcell subframe in the contention access mode. When the mobile terminal is currently in the contention-free access period, the mobile terminal may determine the symbols to be occupied by the to-be-transmitted data signaling from the symbols included in the microcell subframe in the contention-free access mode. The determination of the resources occupied by the data signaling in the contention access mode and in the contention-free access mode is known in the art, and thus will not be particularly defined herein.

In this embodiment of the present disclosure, the contention access period and the content-free access period may be preconfigured in, but not limited to, the following two ways.

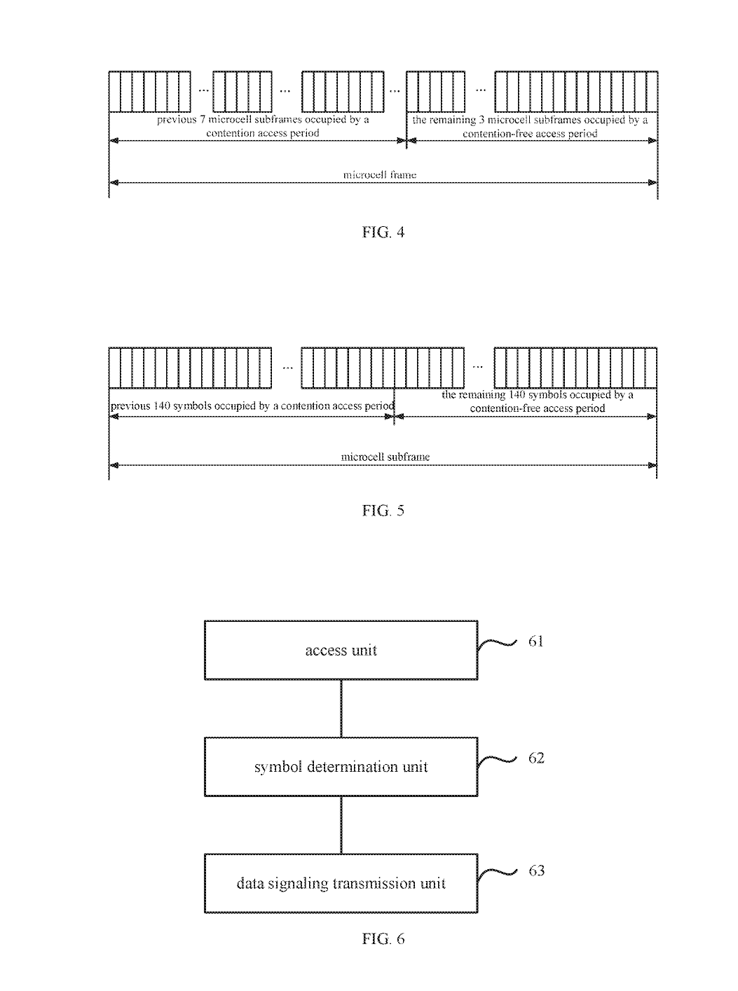

In a first way, as shown in FIG. 4, the microcell frame may be divided in such a manner that the contention access period occupies several subframes of the microcell frame while the contention-free access period occupies the other subframes. For example, the previous 7 microcell subframes included in each microcell frame may be occupied by the contention access period, while the remaining 3 microcell subframes may be occupied by the contention-free access period.

In a second way, as shown in FIG. 5, the microcell subframe may be divided in such a manner than the contention access period occupies several symbols included in the microcell subframe while the contention-free access period occupies the other symbols. For example, the previous 140 symbols included in each microcell subframe may be occupied by the contention access period, while the remaining 140 symbols may be occupied by the contention-free access period.

### Second Embodiment

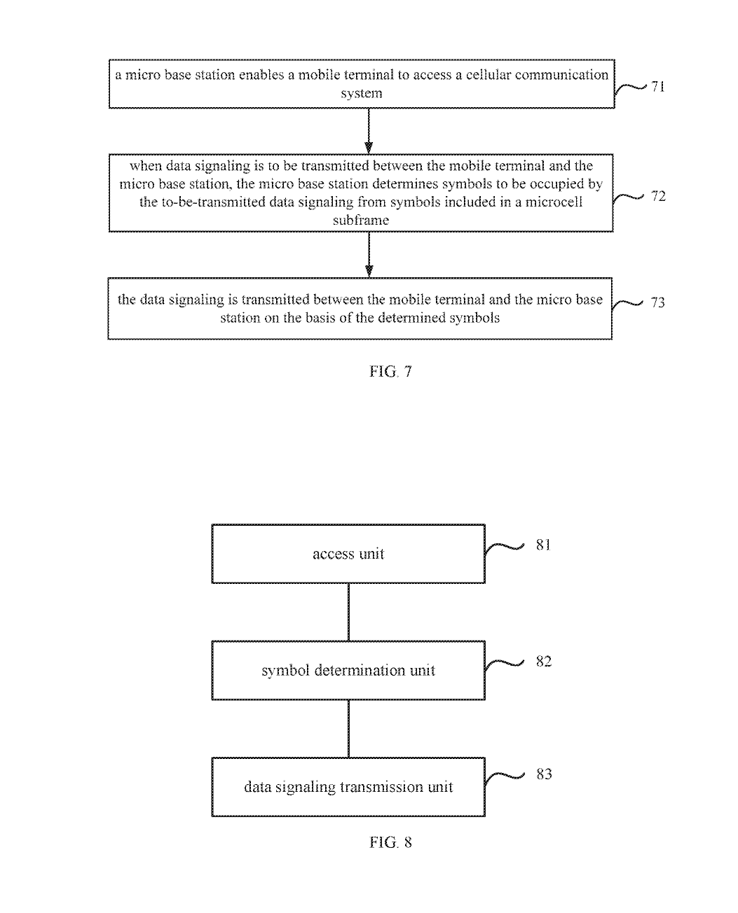

On the basis of the heterogeneous network communication method in the first embodiment, the present disclosure further provides in this embodiment a mobile terminal. As shown in FIG. 6, the mobile terminal includes an access unit 61 configured to access a cellular communication system via a micro base station, a symbol determination unit 62 configured to, when data signaling is to be transmitted between the mobile terminal and the micro base station, determine symbols to be occupied by the to-be-transmitted data signaling from symbols included in a microcell subframe, and a data signaling transmission unit 63 configured to transmit the data signaling between the mobile terminal and the micro base station on the basis of the determined symbols.

Optionally, the symbol determination unit 62 is configured to, when the mobile terminal is currently in a preconfigured contention access period, determine the symbols to be occupied by the to-be-transmitted data signaling from the symbols included in the microcell subframe in a contention access mode, and when the mobile terminal is currently in a preconfigured contention-free access period, determine the symbols to be occupied by the to-be-transmitted data signaling from the symbols included in the microcell subframe in a contention-free access mode.

Optionally, the mobile terminal further includes a high-layer signaling reception unit configured to high-layer signaling for the micro base station from a macro base station to which the micro base station belongs.

### Third Embodiment

After a mobile terminal accesses a cellular communication system via a micro base station, information is transmitted between the mobile terminal and the micro base station in accordance with a frame structure of a microcell. To be specific, the micro base station may transmit data signaling to the mobile terminal in accordance with the frame structure of the microcell, and receive data signaling transmitted by the mobile terminal in accordance with the frame structure of the microcell. A procedure of transmitting the data signaling from the micro base station to the mobile terminal and a procedure of receiving by the mobile terminal the data signaling from the mobile terminal will be described in this embodiment.

As shown in FIG. 7, the present disclosure provides in this embodiment a heterogeneous network communication method at a micro base station side, which includes the following steps.

At step 71, a micro base station enables a mobile terminal to access a cellular communication system.

To be specific, the mobile terminal may initially access the cellular communication system via a macro base station by default, and under some special conditions (e.g., when a fault or service saturation occurs for the macro base station), the mobile terminal may access the cellular communication system via the micro base station.

After the mobile terminal accesses the cellular communication system via the macro base station, information is transmitted between the mobile terminal and the macro base station in accordance with a frame structure of a macrocell. FIG. 2 shows the frame structure of the macrocell. Each macrocell subframe includes M symbols, each macrocell frame includes N macrocell subframes, and each macrocell superframe includes L macrocell frames. M may be 14, N may be 10, and L may be 1024.

The information is transmitted between the mobile terminal and the macro base station on the basis of subframes. To be specific, when the information is to be transmitted from the macro base station to the mobile terminal, the macro base station may determine the macrocell subframes to be occupied by the to-be-transmitted information, and then transmit the to-be-transmitted information to the mobile terminal on the basis of the determined macrocell subframes. When the information is to be received by the macro base station from the mobile terminal, the mobile terminal may determine the macrocell subframes to be occupied by the information, and then receive the information from the mobile terminal on the basis of the determined macrocell subframes.

After the mobile terminal accesses the cellular communication system via the macro base station, a switch program may be enabled by the macro base station when the mobile terminal enters a coverage range of a certain micro base station, so as to switch the macro base station to the micro base station and enable the mobile terminal to access the cellular communication system via the micro base station. A procedure for switching the macro base station to the micro base station is known in the art, and thus will not be particularly defined herein.

At step 72, when data signaling is to be transmitted between the mobile terminal and the micro base station, the micro base station determines symbols to be occupied by the to-be-transmitted data signaling from symbols included in a microcell subframe.

In this embodiment of the present disclosure, after the mobile terminal accesses the cellular communication system via the micro base station, a data plane and a control plane of the mobile terminal may be separated from each other. The control plane is mainly controlled by the macro cell and includes access management and mobility management, and the microcell mainly takes charge of the data communication at the data plane. The data signaling is merely transmitted between the mobile terminal and the micro base station, and the high-layer signaling for the micro base station is transmitted by the macro base station to which the micro base station belongs to the mobile terminal. As a result, it is able to reduce a large number of processing resources for the micro base station, ensure the user experience, and facilitate the management and control of the mobile terminal.

At step 73, the data signaling is transmitted between the mobile terminal and the micro base station on the basis of the determined symbols.

In the third embodiment of the present disclosure, the data signaling may be transmitted between the mobile terminal and the micro base station on the basis of symbols. In this way, it is able to prevent the occurrence of such a condition where merely a part of the symbols included in the microcell subframe are occupied by the data signaling, thereby to improve the efficiency of the data transmission between the micro base station and the mobile terminal as well as the throughput of the micro base station, and reduce the data transmission delay for the micro base station.

The transmission of the data signaling between the mobile terminal and the micro base station includes the transmission of the data signal from the micro base station to the mobile terminal and the transmission of the data signal from the mobile terminal to the micro base station. When the data signaling is transmitted from the micro base station to the mobile terminal, the micro base station may determine the symbols to be occupied by the to-be-transmitted data signaling from the symbols included in the microcell subframe, and then transmit the data signaling to the mobile terminal on the basis of the determined symbols. When the data signaling is transmitted from the mobile terminal to the micro base station, the micro base station may determine the symbols to be occupied by the to-be-transmitted data signaling from the symbols included in the microcell subframe, and then receive the data signaling from the mobile terminal on the basis of the determined symbols.

When the micro base station determines the symbols to be occupied by the to-be-transmitted data signaling, the number of the symbols to be occupied may be determined in accordance with a duration desired for transmitting the data signaling between the mobile terminal and the micro base station and a length of each symbol in the frame structure of the microcell. Then, the micro base station may determine the symbols desired for the transmission of the data signaling from the symbols included in the microcell subframe in accordance with the number of the symbols to be occupied.

In addition, in order to further improve the efficiency of the data transmission between the micro base station and the mobile terminal as well as the throughput of the micro base station, the frame structure of the microcell may be reset in such a manner that the number of the symbols included in the microcell subframe is greater than the number of the symbols included in the macrocell subframe. At this point, a length of each symbol included in the microcell subframe is less than that of each symbol included in the macrocell subframe. FIG. 3 shows the frame structure of the microcell, where each microcell subframe includes K symbols, each microcell frame includes N microcell subframes, and each microcell superframe includes L microcell frames. K may be 280.

In this embodiment of the present disclosure, frame synchronization may be maintained between the microcell subframe and the macrocell subframe, so as to switch the data transmission between the macrocell and the microcell rapidly and smoothly. In other words, a length of each microcell subframe (a product of the number of the symbols included in the microcell subframe and a length of each symbol) is equal to a length of each macrocell subframe (a product of the number of the symbols included in the macrocell subframe and a length of each symbol).

In addition, a contention access period and a contention-free access period may be configured for the micro base station by a resource management center at a network side, and then the contention access period, its corresponding contention access mode, the contention-free access period and its corresponding contention-free access mode may be notified by the macro base station to the mobile terminals. Of course, under some special conditions (e.g., when a fault or service saturation occurs for the macro base station), they may also be notified by the micro base station to the mobile terminals.

When the micro base station determines the symbols to be occupied by the to-be-transmitted data signaling, the micro base station may determine whether it is currently in the contention access period or the content-free access period. When the micro base station is currently in the contention access period, the micro base station may determine the symbols to be occupied by the to-be-transmitted data signaling from the symbols included in the microcell subframe in the contention access mode. When the micro base station is currently in the contention-free access period, the micro base station may determine the symbols to be occupied by the to-be-transmitted data signaling from the symbols included in the microcell subframe in the contention-free access mode.

The configuration ways for the contention access period and the contention-free access period are identical to those mentioned in the first embodiment, and thus will not be particularly defined herein.

### Fourth Embodiment

On the basis of the heterogeneous network communication method in the third embodiment, the present disclosure provides in this embodiment a micro base station. As shown in FIG. 8, the micro base station includes an access unit 81 configured to enable a mobile terminal to access a cellular communication system, a symbol determination unit 82 configured to, when data signaling is to be transmitted between the micro base station and the mobile terminal, determine symbols to be occupied by the to-be-transmitted data signaling from symbols included in a microcell subframe, and a data signaling transmission unit 83 configured to transmit the data signaling between the micro base station and the mobile terminal on the basis of the symbols determined by the symbol determination unit 82.

Optionally, the symbol determination unit 82 is configured to, when the micro base station is currently in a preconfigured contention access period, determine the symbols to be occupied by the to-be-transmitted data signaling from the symbols included in the microcell subframe in a contention access mode: and when the micro base station is currently in a preconfigured contention-free access period, determine the symbols to be occupied by the to-be-transmitted data signaling from the symbols included in the microcell subframe in a contention-free access mode.

The above are merely the preferred embodiments of the present disclosure. Obviously, a person skilled in the art may make further modifications and improvements without departing from the spirit of the present disclosure, and these modifications and improvements shall also fall within the scope of the present disclosure.

1. A heterogeneous network communication method, comprising steps of:
enabling a mobile terminal to access a cellular communication system via one of a micro base station and a macrocell base station;
when data signaling is to be transmitted between the mobile terminal and the micro base station, determining, by the mobile terminal, symbols to be occupied by the to-be-transmitted data signaling from symbols comprised in a microcell subframe; and
transmitting the data signaling between the mobile terminal and the micro base station on the basis of the determined symbols;
when data signaling is to be transmitted between the mobile terminal and the macrocell base station, determining, by the mobile terminal, symbols to be occupied by the to-be-transmitted data signaling from symbols comprised in a macrocell subframe; transmitting the data signaling between the mobile terminal and the macrocell base station on the basis of the determined symbols.

2. The heterogeneous network communication method according to claim 1, wherein the number of the symbols comprised in the microcell subframe is greater than the number of the symbols comprised in the macrocell subframe.

3. The heterogeneous network communication method according to claim 2, wherein the macrocell subframe comprises M symbols, a macrocell frame comprises N macrocell subframes, a macrocell superframe comprises L macrocell frames;
wherein the microcell subframe comprises K symbols, a microcell frame comprises N microcell subframes, a microcell superframe comprises L microcell frames, and K is greater than M.

4. The heterogeneous network communication method according to claim 2, wherein frame synchronization is maintained between the microcell subframe and the macrocell subframe.

5. The heterogeneous network communication method according to claim 1, wherein the step of determining, by the mobile terminal, the symbols to be occupied by the to-be-transmitted data signaling from the symbols comprised in the microcell subframe comprises:
when the mobile terminal is currently in a preconfigured contention access period, determining, by the mobile terminal, the symbols to be occupied by the to-be-transmitted data signaling from the symbols comprised in the microcell subframe in a contention access mode; and
when the mobile terminal is currently in a preconfigured contention-free access period, determining, by the mobile terminal, the symbols to be occupied by the to-be-transmitted data signaling from the symbols comprised in the microcell subframe in a contention-free access mode.

6. The heterogeneous network communication method according to claim 5, wherein several subframes of the microcell frame or several symbols of the microcell subframe are occupied by each contention access period.

7. The heterogeneous network communication method according to claim 1, further comprising: receiving high-layer signaling for the micro base station from a macro base station to which the micro base station belongs.

8. A mobile terminal, comprising:
an access unit configured to access a cellular communication system via one of a micro base station and a macrocell base station;
a symbol determination unit configured to, when data signaling is to be transmitted between the mobile terminal and the micro base station, determine symbols to be occupied by the to-be-transmitted data signaling from symbols comprised in a microcell subframe, when data signaling is to be transmitted between the mobile terminal and the macrocell base station, determine symbols to be occupied by the to-be-transmitted data signaling from symbols comprised in a macrocell subframe; and
a data signaling transmission unit configured to transmit the data signaling between the mobile terminal and one of the micro base station and the macrocell base station on the basis of the determined symbols.

9. The mobile terminal according to claim 8, wherein the symbol determination unit is configured to, when the mobile terminal is currently in a preconfigured contention access period, determine the symbols to be occupied by the to-be-transmitted data signaling from the symbols comprised in the microcell subframe in a contention access mode, and when the mobile terminal is currently in a preconfigured contention-free access period, determine the symbols to be occupied by the to-be-transmitted data signaling from the symbols comprised in the microcell subframe in a contention-free access mode.

10. The mobile terminal according to claim 8, further comprising:
a high-layer signaling reception unit configured to receive high-layer signaling for the micro base station from a macro base station to which the micro base station belongs.

11. A heterogeneous network communication method, comprising:
enabling, by a micro base station, a mobile terminal to access a cellular communication system;
when data signaling is to be transmitted between the micro base station and the mobile terminal, determining, by the micro base station, symbols to be occupied by the to-be-transmitted data signaling from symbols comprised in a microcell subframe; and
transmitting the data signaling between the micro base station and the mobile terminal on the basis of the determined symbols.

12. The heterogeneous network communication method according to claim 11, wherein the number of the symbols comprised in the microcell subframe is greater than the number of the symbols comprised in a macrocell subframe.

13. The heterogeneous network communication method according to claim 12, wherein the macrocell subframe comprises M symbols, a macrocell frame comprises N macrocell subframes, a macrocell superframe comprises L macrocell frames;
wherein the microcell subframe comprises K symbols, a microcell frame comprises N microcell subframes, a microcell superframe comprises L microcell frames, and K is greater than M.

14. The heterogeneous network communication method according to claim 12, wherein frame synchronization is maintained between the microcell subframe and the macrocell subframe.

15. The heterogeneous network communication method according to claim 11, wherein the step of determining, by the micro base station, the symbols to be occupied by the to-be-transmitted data signaling from the symbols comprised in the microcell subframe comprises:
when the micro base station is currently in a preconfigured contention access period, determining, by the micro base station, the symbols to be occupied by the to-be-transmitted data signaling from the symbols comprised in the microcell subframe in a contention access mode; and
when the micro base station is currently in a preconfigured contention-free access period, determining, by the micro base station, the symbols to be occupied by the to-be-transmitted data signaling from the symbols comprised in the microcell subframe in a contention-free access mode.

16. The heterogeneous network communication method according to claim 15, wherein several subframes of the microcell frame or several symbols of the microcell subframe are occupied by each contention access period.

17. A micro base station for performing the heterogeneous network communication method according to claim 11, comprising:
an access unit configured to enable a mobile terminal to access a cellular communication system;
a symbol determination unit configured to, when data signaling is to be transmitted between the micro base station and the mobile terminal, determine symbols to be occupied by the to-be-transmitted data signaling from symbols comprised in a microcell subframe; and
a data signaling transmission unit configured to transmit the data signaling between the micro base station and the mobile terminal on the basis of the determined symbols.

18. The micro base station according to claim 17, wherein the symbol determination unit is configured to, when the micro base station is currently in a preconfigured contention access period, determine the symbols to be occupied by the to-be-transmitted data signaling from the symbols comprised in the microcell subframe in a contention access mode; and when the micro base station is currently in a preconfigured contention-free access period, determine the symbols to be occupied by the to-be-transmitted data signaling from the symbols comprised in the microcell subframe in a contention-free access mode.

19. The heterogeneous network communication method according to claim 3, wherein frame synchronization is maintained between the microcell subframe and the macrocell subframe.

20. The heterogeneous network communication method according to claim 13, wherein frame synchronization is maintained between the microcell subframe and the macrocell subframe.
